(19) United States
(12) Patent Application Publication
(10) Pub. No.: US 2012/0143769 A1
(43) Pub. Date: Jun. 7, 2012

(54) COMMERCE CARD

(75) Inventors: Murali R. Krishnan, Clyde Hill, WA (US); Anoop Anantha, Kirkland, WA (US)

(73) Assignee: MICROSOFT CORPORATION, Redmond, WA (US)

(21) Appl. No.: 12/958,773

(22) Filed: Dec. 2, 2010

(51) Int. Cl. G06Q 20/00; G06Q 30/00; G06F 21/00

(52) U.S. Cl. 705/71; 705/14.27

(57) ABSTRACT

Commerce card techniques are described. In one or more implementations, one or more credentials are received at a commerce card, the credentials encrypted using a public key. The one or more credentials are decrypted using a private key that corresponds to the public key, the decrypting performed by a secure element implemented in tamper-resistant hardware of the commerce card without exposing the private key outside of the secure element. The decrypted one or more credentials are stored within the secure element of the commerce card such that the decrypted one or more credentials are not exposed outside of the secure element, the one or more credentials usable by the commerce card as part of a transaction to purchase a good or service.

### BACKGROUND

Even thought the prevalence of smart phones is ever increasing, the cost of the smart phones may hinder ubiquitous distribution. For example, in emerging markets and elsewhere it may be difficult for prospective consumers to pay for monthly service fees, much less purchase a smart phone even though the cost of smart phones continues to decrease. Therefore, functionality that involved use of the smart phone may not be available to a large segment of the population. This may become especially difficult as this functionality becomes increasingly tied to situations encountered in everyday life.

### SUMMARY

Commerce card techniques are described. In one or more implementations, one or more credentials are received at a commerce card, the credentials encrypted using a public key. The one or more credentials are decrypted using a private key that corresponds to the public key, the decrypting performed by a secure element implemented in tamper-resistant hardware of the commerce card without exposing the private key outside of the secure element. The decrypted one or more credentials are stored within the secure element of the commerce card such that the decrypted one or more credentials are not exposed outside of the secure element, the one or more credentials usable by the commerce card as part of a transaction to purchase a good or service.

In one or more implementations, data is transmitted by a commerce card to a merchant to purchase a good or service from the merchant, the commerce card having a form factor that approximates a credit card and a secure element implemented using a tamper-resistant integrated circuit to protect one or more credentials, stored therein, that are usable to protect the data from snooping. One or more credentials are located by the commerce card that corresponds to a loyalty offer of the merchant. The located one or more credentials are transmitted by the commerce card for receipt by the merchant.

In one or more implementations, a commerce card comprises a housing configured to assume a height and width of a credit card, a display device disposed on the housing, one or more input devices configured to navigate through data displayed by the display device, at least a portion of which pertains to an ability of the commerce card to participate in purchasing a good or service, a communication module disposed within the housing and including one or more antennas configured to communicate wirelessly using near field technology, and a secure element implemented as a single tamper-resistant integrated circuit that is configured to store one or more credentials that include a private key usable to perform one or more decryption operations without exposing the private key outside of the secure element and one or more credentials that are configured for involvement in the purchasing of the good or service.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different instances in the description and the figures may indicate similar or identical items.

FIG. 1 is an illustration of an example implementation of a commerce card in accordance with one or more embodiments of devices, features, and systems for techniques described herein.

FIG. 2 is an illustration of an example implementation of a system that is operable to employ the commerce card techniques described herein.

FIG. 3 is a flow diagram depicting a procedure in an example implementation in which a commerce card is provisioned with one or more credentials usable to purchase a good or service.

FIG. 4 is a flow diagram depicting a procedure in an example implementation in which a commerce card is utilized to purchase a good or service and to participate in a loyalty offer.

### DETAILED DESCRIPTION

Overview

The functionality of smart phones continues to increase such that users are able to perform a variety of tasks. Indeed, this functionality may also extend “beyond” the smart phone to situations encountered in everyday life. However, even though the number of smart phones continues to increase, there may be a segment of the population that is not able or not willing to use a smart phone. Therefore, this segment of the population may be prevented from easily interacting with this everyday functionality that may become increasingly more reliant on use of a smart phone by a consumer.

Commerce card techniques are described. In implementations, a commerce card is configured according to a form factor of a credit card and includes an integrated display and a secure element. The secure element is implemented in hardware to be resistant to tampering and “snooping.” Therefore, data may be stored within the secure element that has a decreased likelihood of being discovered, which may serve to support a wide variety of functionality.

One example of this functionality is an ability to store credentials in the commerce card that are usable to purchase goods or services, participate in loyalty offers, use for identification, and so on. For example, the secure element may be configured to answer challenges, provide account information, and so on and thus function as an “eWallet.” In this way, a user may utilize the commerce card to purchases goods or services of interest without involving purchase of a smart phone to use this functionality.

In the following discussion, a variety of example implementations of a commerce card are described. Additionally, a variety of different functionality that may be employed by the commerce card is described for each example, which may be implemented in that example as well as in other described examples. Although a commerce card having a form factor of a credit card is described, a variety of other devices are also contemplated. Example procedures are then described which may be performed using the example devices and elsewhere. Accordingly, example implementations are illustrated of a few of a variety of contemplated implementations and are not limited to performance of the example procedures and vice versa.

Example Implementations

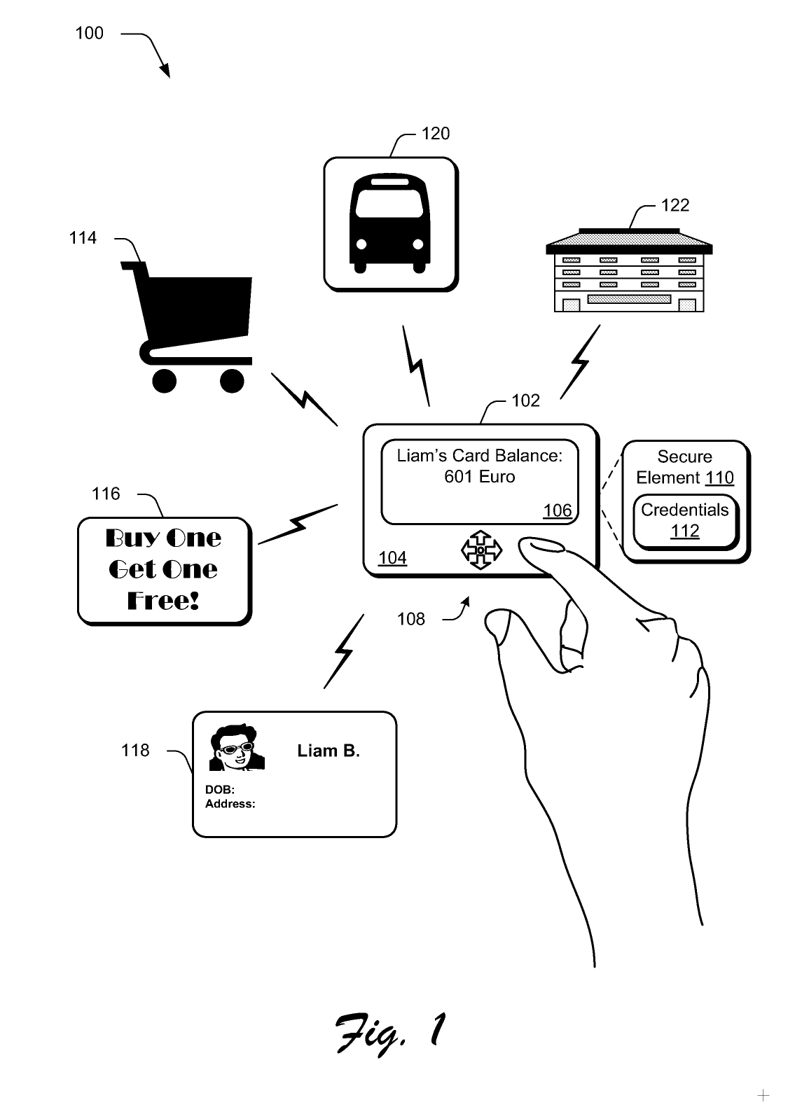

FIG. 1 illustrates an environment 100 in an example implementation that shows examples of functionality that may be interacted with using a commerce card. The commerce card 102 in this example is illustrated as employing a housing 104 that follows a general form factor of a credit card. The form factor, for instance, may approximate a height and width of a credit card but have a slightly greater depth. The housing 104 may be formed from a variety of materials and configured from a variety of different pieces, such as opposing plastic shells that “snap” together, metal portions that slide together, and so on.

The housing 104 is illustrated as having a display device 106 disposed therein and navigation buttons 108 that may be used to navigate through data displayed on the display device 106. A secure element 110 having one or more credentials 112 is further illustrated as be disposed within the housing 104.

The secure element 110, for instance, may be configured as an integrated circuit made to be tamper resistant. Thus, the secure element 110 may reduce a likelihood of snooping and other techniques that are usable by a malicious party to compromise the credentials 112 stored therein.

Secure storage of the credentials 112 in the secure element 110 may be leveraged for a variety of purposes. The credentials 112, for instance, may be used to purchase a good or service from a merchant 114. The credentials 112 may also be utilized to participate in a loyalty offer 116 of the merchant 114. The credentials 112, for instance, may supply billing information as well as identify a loyalty offer 116. Therefore, a purchase made using the commerce card 102 may automatically involve communication of credentials 112 to participate in a loyalty offer of the merchant, such as to “buy one get one free” and so on.

The credentials 112 may also be used as identification 118. Identification 118 may involve a variety of different techniques, such as to function as a driver's license, passport, and so on. Thus, identification 118 in this example is used to verify that a user of the commerce card 102 “is who they say they are.”

The credentials 112 may also be used for access. For example, the credentials 112 may be used to access transit 120, such as a bus pass, rail pass, and so on. The credentials 112 may also be used to access a premises 122, such as an apartment, hotel, office, and so on. Thus, the credentials 112 may be utilized for a wide variety of purposes. Further discussion of provisioning of the credentials 112 in the secure element 110 of the commerce card 102 and use of the credentials for these and other purposes may be found in relation to the following figure.

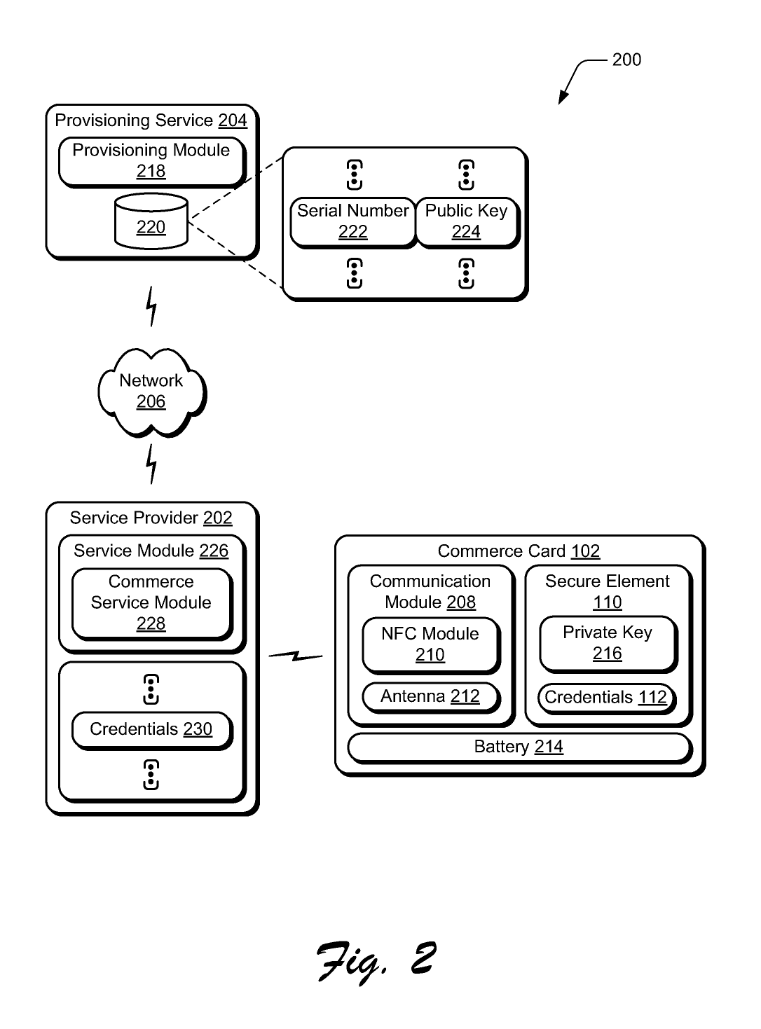

FIG. 2 is an illustration of an example implementation of an environment 200 that is operable to employ the commerce card techniques described herein. The environment includes the commerce card 102 along with a service provider 202 and a provisioning service 204. The service provider 202 and the provisioning service 204 are illustrated as communicatively coupled, one to another, via a network 206. Although the network 206 is illustrated as the Internet, the network may assume a wide variety of configurations. For example, the network 108 may include a wide area network (WAN), a local area network (LAN), a wireless network, a public telephone network, an intranet, and so on. Further, although a single network 206 is shown, the network 206 may be representative of multiple networks.

The commerce card 102 is illustrated as including a communication module 208. The communication module 208 is representative of functionality of the commerce card 102 to communicate using wireless techniques. For example, the communication module 208 may include a near field communication (NFC) module 210 and antenna 212 that are powered by a battery 214 to communicate wirelessly with the service provider 202 using near field technology. Other local wireless communications methods are also contemplated and may be implemented instead of or in addition to the NFC module 210.

The commerce card 102 is further illustrated as including a secure element 110. In one or more implementations, the secure element 110 is representative of functionality to support secure communications with the commerce card 102. For example, the secure element 110 may be implemented using hardware and configured during manufacture to include a private key 216. For instance, the secure element 110 may be implemented by a manufacturer of the device using a tamper-resistant integrated circuit that is resistant to “snooping” as well as physical removal from the commerce card 102, e.g., by covering a surface-mounted integrated circuit with an epoxy that helps to prevent snooping of the circuit as well as causing the circuit to break if removal is attempted.

In implementations, the secure element 110 includes functionality to perform encryption and/or decryption operations. For example, the secure element 110 may use the private key 216 to perform a decryption operation and expose a result of the operations to other functionality of the commerce card 102, such as to the communication module 208 for communication to the service provider 202. In this example, the secure element 110 may receive data to be decrypted from the service provider 202, decrypt the data using the private key 216, and then expose a result of the decryption operation (i.e., the decrypted data) to the communication module 208 for communication back to the service provider 202. This may be used for a variety of purposes as further detailed below. Therefore, inclusion of the private key 216 in the secure element 110 may help to protect the private key 216 from discovery “outside” the secure element 110 by keeping the private key 216 from being exposed “in the clear” during the decryption operation.

A variety of other functionality may also be supported through use of the secure element 110. For example, the secure element 110 may support a protected communication channel through the provisioning service 204. The provisioning service 204, for instance, may include a provisioning module 218 and storage 220. The storage 220 may be used to maintain a serial number 222 assigned to an integrated circuit that includes the secure element 110 and a corresponding public key 224 that forms an asymmetric public/private key pair with the private key 216 of the commerce card 102. The provisioning module 118 may thus provide the public key 124 to third-party services (e.g., the service provider 202) such that communication between the third-party service and the commerce card 102 is protected.

For example, a user of the commerce card 102 may interact with the communication module 208 or other functionality to communicate with the service provider 202 over a near field communication link. The service provider 202 as illustrated includes a service module 226 that is representative of functionality to provide one or more services. For example, the service module 226 may include a commerce service module 228 that is representative of functionality to provide functionality relating to the commerce card 102.

In an example, the commerce service module 228 is used to provision credentials 230 securely on the commerce card 102 in the secure element 110. Secure communication of the credentials 230 to the commerce card may be implemented in a variety of ways.

In one instance, the public key 224 is provided to secure communications between the service provider 202 and the commerce card 102 directly. For example, the public key 124 may be located by the provisioning module 218 of the provisioning service 204 by obtaining a serial number 222 for the integrated circuit that implements the secure element 110, e.g., from the commerce card 102. The provisioning module 218 may then use the serial number 222 to locate the public key 224 and provide the public key 124 to the service provider 202. The public key 224 may then be used to encrypt data to be communicated to the commerce card 102, such as the credentials 230.

In this way, regardless of how the communication between the service provider 202 and the commerce card 102 is performed, the credentials 230 (e.g., the other cryptographic keys) are protected from discovery through encryption using the public key 224. Therefore, an intermediary that may be used to communicate between the service provider 202 and the commerce card 102 is not able to determine “what” is being communicated.

The commerce card 102 may then decrypt the communication using the secure element 110, and more particularly the private key 216, to obtain the credentials 230. The credentials 230 may assume a variety of configurations such as other cryptographic keys, identifiers, and so on and store them as credentials 230.

In one technique, the credentials 230 received from the service provider 202 are exposed for use outside the secure element 110, such as to the communication module 208 or other functionality of the commerce card 102. Thus, in this technique the secure element 110 is leveraged to provide the credentials that are used to serve as a basis to secure communications but is not used to secure the communications itself, i.e., to provide the actual encryption/decryption.

In another technique, the credentials 230 received from the service provider 202 may be kept from being exposed outside the secure element 110 through storage within the secure element 110. The secure element 110 may then use the credentials 112 (e.g., cryptographic keys) to decrypt and/or encrypt data received by the secure element 110 without exposing the cryptographic keys “outside” the secure element 110. Thus, the secure element 110 may leverage a variety of different techniques to secure communications with the commerce card 102, the example of the service provider 202 being but one of many such examples. Additionally, the credentials 112 may be leveraged by the secure element 110 of the commerce card in a variety of ways, examples of which may be found in relation to the following sections.

Authorization Using Credentials of the Secure Element

In this example, the secure element 110 is leveraged to authorize a user of the commerce card 102, such as to verify an identity 118, permit access to transit 120 or premises 122, and so on. The commerce card 102, for instance, may be used to store credentials 112 to verify a “identity” of a user of the device. This identity may then be provided to other parties (e.g., service provider 202, a merchant, and so on) to verify that the user “is who they say they are.” In one such implementation, the commerce card 102 may be “tapped” against a NFC reader at a physical location of the entity that desires to verify the identity of a user of the commerce card 102, such as a service provider 202. This tap may cause communication between the service provider 202 and the commerce to verify the identity of the user using the credentials 112. In another example, this identity may be used to sign documents using the commerce card 102. Further, the commerce card 102 may be configured to maintain a plurality of such identities for verification by a plurality of different entities.

For example, a user may take commerce card 102 to a passport office along with physical documents that are usable to authenticate the user's identity, such as a driver's license, social security card, and so on. An employee or other person at the passport office may then examine the documents to authenticate that the user “is who they say they are.”

The employee may then initiate an operation to provision credentials on the secure element 110 of commerce card 102 at the physical location, e.g., by acting as the service provider 202. For example, a computing device at the passport office may be used to securely provide credentials to the commerce card 102 over a local connection (e.g., NFC) between the computing device and the commerce card 102, which may be referred to as “proximity programming.” For instance, the credentials may be communicated responsive to tapping the device on an NFC reader of the service provider 202 and read using near field technology.

The credentials 230 may be generated locally by the computing device at the service provider 202, obtained remotely over the network 206, and so on. Thus, the credentials may be securely maintained by a commerce card 102 of the user, which may support a variety of different functionality.

Continuing with the previous example, a user may encounter a situation that involves authentication of the user's identity, such as travel to a foreign country following the previous passport example. Upon entering immigration, the foreign country may demand a passport.

In response, credentials 112 from the secure element 110 may be communicated securely to a requestor of the authentication. The user, for instance, may “tap” the commerce card 102 against a reader. Credentials 112 from the secure element 110 may then be used to authenticate the user, such as to obtain an electronic copy of the user's passport from a service over a network 206. Further, the commerce card 102 may be used also to sign paperwork using credentials 112 stored in the secure element 110, such as to sign a declaration form. Thus, the commerce card 102 may serve as a ready source to authenticate an identity of the user.

Although these examples describe communicating credentials that are stored in the secure element, the credentials may also be used to answer challenges to authenticate a user's identity. For example, the commerce card 102 may receive data, process the data in the secure element 110 using the credentials 112 (e.g., one or more cryptographic keys), and provide a result to the service provider 202 using the communication module 208. The result may then be verified by the service provider 202 and determine that the commerce card 102 is “legitimate” without communication the credentials 112 “outside” of the secure element 110. Although these examples described authentication of a user's identity for passport purposes, similar techniques may be used for transit 120, to access a premises 122, as a driver's license, social security card, and so on.

Transactions with Merchants 114 and Loyalty Offers 116

Loyalty offers 116 may be used by merchants to promote business with the merchant. For example, a merchant may offer a discount for a purchase of gas for every “X” amount of groceries purchased, offer an 11^{th} cup of coffee free after purchase of ten cups, a discount based on a dollar amount of purchased media, and so on. In this way, a consumer may be incentivized to purchase goods or services from a particular merchant.

However, a consumer may be confronted with a variety of different loyalty offers from a variety of different merchants. Further, the different merchants may employ different techniques to track the consumer's loyalty in relation to qualifying for the offer, such as punch cards, magnetic swipe cards, and so on. Consequently, a user may be confronted with a wide variety of different types of cards that may consume a limited amount of space in the user's wallet. Thus, this may be inefficient and interfere with the user's ability to particulate with the loyalty offers.

In implementations, the commerce card 102 may be utilized to maintain data related to participation in one or more loyalty offers 116. For example, the commerce card 102 may be configured to maintain an “electronic wallet” that includes credentials 112 to purchase goods or services. The wallet may also be configured to maintain credentials 112 to participate in a loyalty offer. The credentials 112 to initiate the purchase and participate in the loyalty offer 116 may be communicated together, separately (after navigation through a display on the display device 106), and so on. In this way, a user may efficiently interact with merchants 114 to purchase goods or services as well as participate in loyalty offers 116 of the merchant.

For instance, the commerce card 102 may be carried by a user of the commerce card 102 to a physical location of a merchant, such as a traditional “bricks and mortar” store. The commerce card 102 may then be used to communicate transaction credentials (e.g., credit card information, a user login and password, and so on) and loyalty credentials (e.g., a loyalty identifier) to the merchant to initiate the transaction. The credentials may be communicated in a variety of ways, such as by using near field technology to communicate wirelessly over a short distance. The merchant may then continue processing the transaction credentials (including the loyalty identifier 212) to complete the purchase as well as to process participation with the loyalty offers 116.

Generally, any of the functions described herein can be implemented using software, firmware, hardware (e.g., fixed logic circuitry), or a combination of these implementations. The terms “module” and “functionality” as used herein generally represent hardware, software, firmware, or a combination thereof In the case of a software implementation, the module, functionality, or logic represents instructions and hardware that performs operations, e.g., one or more processors and/or functional blocks.

The instructions can be stored in one or more computer-readable media. One such configuration of a computer-readable medium is signal bearing medium and thus is configured to transmit the instructions (e.g., as a carrier wave) to the hardware of the computing device, such as via the network 104. The computer-readable medium may also be configured as a computer-readable storage medium and thus is not a signal bearing medium. Examples of a computer-readable storage medium include a random-access memory (RAM), read-only memory (ROM), an optical disc, flash memory, hard disk memory, and other memory devices that may use magnetic, optical, and other techniques to store instructions and other data. The features of the techniques described below are platform-independent, meaning that the techniques may be implemented on a variety of commercial computing platforms having a variety of hardware configurations.

Example Procedures

The following discussion describes commerce card techniques that may be implemented utilizing the previously described systems and devices. Aspects of each of the procedures may be implemented in hardware, firmware, software, or a combination thereof The procedures are shown as a set of blocks that specify operations performed by one or more devices and are not necessarily limited to the orders shown for performing the operations by the respective blocks. In portions of the following discussion, reference will be made to the environment 100 and systems 200 of FIGS. 1-2, respectively.

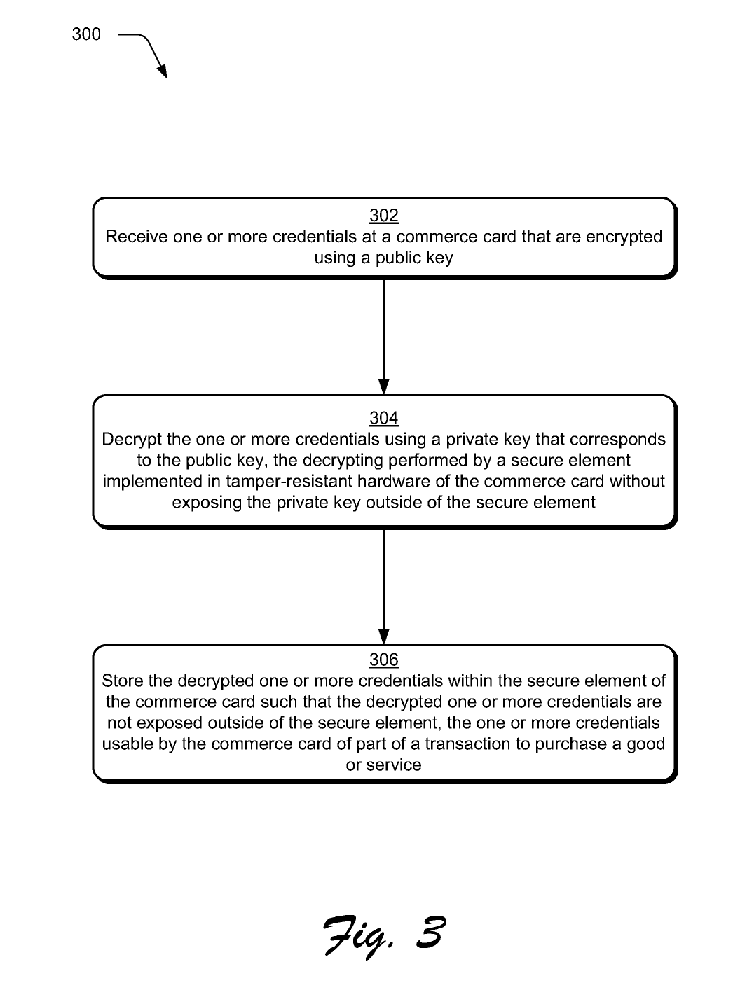

FIG. 3 depicts a procedure 300 in an example implementation in which a commerce card is provisioned with one or more credentials usable to purchase a good or service. One or more credentials are received at a commerce card that are encrypted using a public key (block 302). The commerce card 102, for instance, may be taken to a physical location, e.g., a point of sale of a merchant, a financial institution (e.g., a bank, credit union), and so on. The physical location may include a NFC reader/writer that may be used to “top off” the commerce card 102, such as after a user of the card has provided cash to a merchant. For example, a user of the commerce card 102 may “tap” the commerce card 102 again a terminal to cause the terminal to perform proximity programming to stored credentials therein. In response, credentials may be received at the commerce card 102 that are usable to purchase a good or service, e.g., credit card information, cryptographic keys configured to authorize access to an account, account information, and so on.

The credentials may be encrypted using a public key that corresponds to a private key of the commerce card 102. For example, a serial number 222 may be used in conjunction with a provisioning service 204 to locate the public key 224, which may then be provided to the merchant to encrypt the credentials.

The one or more credentials are decrypted using a private key that corresponds to the public key, the decrypting performed by a secure element implemented in tamper-resistant hardware of the commerce card without exposing the private key outside of the secure element (block 304). Continuing with the previous example, the commerce card 102 may receive the encrypted credentials. The encrypted credentials may then be decrypted using the private key 216 contained in the secure element 110. The private key 216, for instance, may be installed by a manufacturer, distributor, and so on. Further the secure element 110 may be configured to be tamper resistant and as such resist attempts by “outside” parties (e.g., malicious parties) to obtain data stored therein. In an implementation, the secure element 110 is formed from a single integrated circuit that is configured to break if removal is attempted, thereby rendering the secure element 110 inoperable. A variety of other examples of tamper-resistant hardware are contemplated.

The decrypted one or more credentials are stored within the secure element of the commerce card such that the decrypted one or more credentials are not exposed outside of the secure element, the one or more credentials usable by the commerce card as part of a transaction to purchase a good or service (block 306). Continuing yet again with the previous example, the secure element may decrypt the credentials using functionality contained within such that neither the credentials to be decrypted nor the data used to decrypt the credentials (e.g., the private key) are exposed “outside” the secure element.

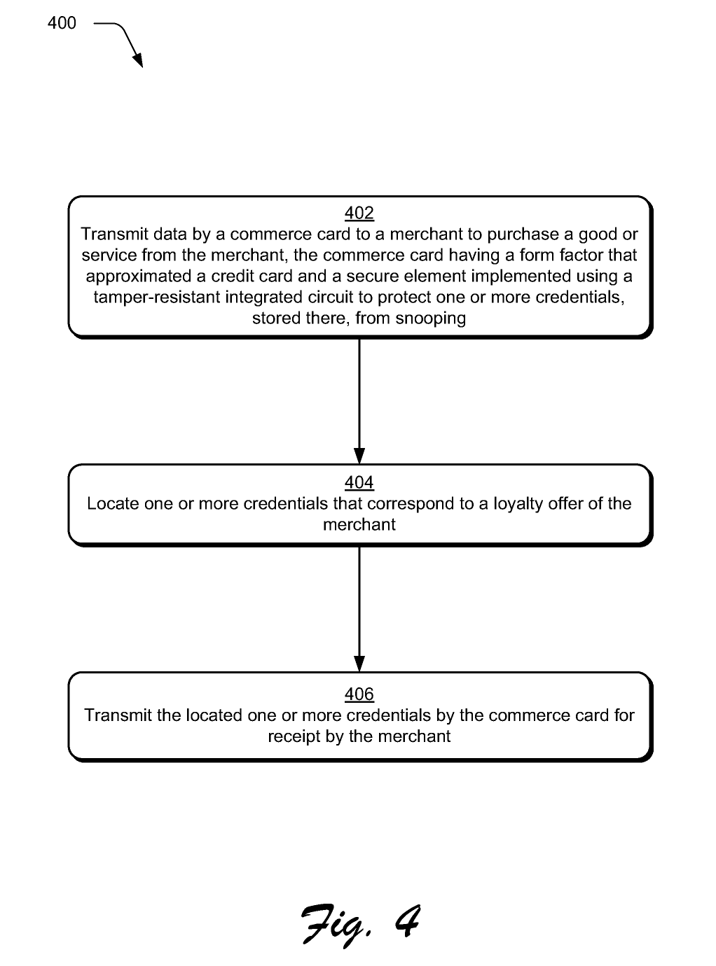

FIG. 4 depicts a procedure 400 in an example implementation in which a commerce card is utilized to purchase a good or service and to participate in a loyalty offer. Data is transmitted by a commerce card to a merchant to purchase a good or service from the merchant, the commerce card having a form factor that approximates a credit card and a secure element implemented using a tamper-resistant integrated circuit to protect one or more credentials, stored therein, from snooping (block 402). As before, the commerce card 102 may assume dimensions that approximate a height and width of a credit card with a depth that might be slightly greater. This commerce card 102 may be used to purchase a good or service at a merchant, such as by “tapping” the card against a NFC reader to transmit credentials from the secure element 110 to purchase a good or service.

One or more credentials are located that correspond to a loyalty offer of the merchant (block 404). The commerce card 102 may further be configured to automatically provide credentials that are usable to participate in a loyalty offer of the merchant. A user, for instance, may manually select the credentials, the credentials may be automatically communicated in response to a merchant identifier and so on. The located one or more credentials are transmitted by the commerce card for receipt by the merchant (block 406), such as by using wireless techniques that include NFC.

### CONCLUSION

Although the invention has been described in language specific to structural features and/or methodological acts, it is to be understood that the invention defined in the appended claims is not necessarily limited to the specific features or acts described. Rather, the specific features and acts are disclosed as example forms of implementing the claimed invention.

What is claimed is:

1. A method comprising:
receiving one or more credentials at a commerce card that are encrypted using a public key;
decrypting the one or more credentials using a private key that corresponds to the public key, the decrypting performed by a secure element implemented in tamper-resistant hardware of the commerce card without exposing the private key outside of the secure element; and
storing the decrypted one or more credentials within the secure element of the commerce card such that the decrypted one or more credentials are not exposed outside of the secure element, the one or more credentials usable by the commerce card as part of a transaction to purchase a good or service.

2. A method as described in claim 1, wherein the commerce card is configured to assume a form factor that approximates a credit card.

3. A method as described in claim 2, wherein a height and a width of a housing of the commerce card corresponds to a height and width of the credit card and a depth of the housing of the commerce card is greater than a depth of the credit card.

4. A method as described in claim 1, wherein the commerce card is configured to use the one or more credentials as part of the transaction to purchase the good or service after entry of a PIN using one or more input devices of the commerce card.

5. A method as described in claim 1, wherein the one or more credentials represent a specific monetary amount that is usable to purchase the good or service.

6. A method as described in claim 1, wherein the one or more credentials are received at the commerce card locally from a point of sale terminal of a merchant.

7. A method as described in claim 6, wherein the one or more credentials are received at the commerce card locally from a point of sale terminal of a merchant after cash is provided to the merchant.

8. A method as described in claim 1, wherein the one or more credentials are received at the commerce card locally using proximity programming by tapping the commerce card against a reader.

9. A method as described in claim 1, further comprising:
receiving a credential at the commerce card that is encrypted using a public key, the credential usable to participate in loyalty offer;
decrypting the credential using the private key by the secure element without exposing the private key outside of the secure element; and
storing the credential at the commerce card.

10. A method as described in claim 1, wherein the commerce card includes a display device that is usable to display a balance associated with credentials stored in the secure element and one or more input devices configured to navigate through the display.

11. A method as described in claim 1, wherein the commerce card is configured to communicate using near field technology and is not configured to communicate using telephone functionality.

12. A method comprising.
transmitting data by a commerce card to a merchant to purchase a good or service from the merchant, the commerce card having a form factor that approximates a credit card and a secure element implemented using a tamper-resistant integrated circuit to protect one or more credentials, stored therein, that are usable to protect the data from snooping;
locating one or more credentials by the commerce card that correspond to a loyalty offer of the merchant; and
transmitting the located one or more credentials by the commerce card for receipt by the merchant.

13. A method as described in claim 12, wherein the one or more credentials are stored within the secure element.

14. A method as described in claim 12, wherein the commerce card includes:
a display device disposed in a housing to display data;
one or more buttons disposed on the housing to navigate through the display of data to provide an input to perform the locating; and
a communication module configured to wirelessly perform the transmitting of the data and the located one or more credentials to the merchant using near field communication.

15. A method as described in claim 12, wherein the commerce card is configured to display on a display device of the commerce card a current state of participation in the loyalty offer by a user.

16. A method as described in claim 12, wherein the locating is performed responsive to receipt of an identifier of the merchant of the loyalty offer from the merchant.

17. A method as described in claim 12, wherein the commerce card is not configured to include telephone functionality including making or receiving a telephone call.

18. A commerce card comprising:
a housing configured to assume a height and width of a credit card;
a display device disposed on the housing;
one or more input devices configured to navigate through data displayed by the display device, at least a portion of which pertains to an ability of the commerce card to participate in purchasing a good or service;
a communication module disposed within the housing and including one or more antennas configured to communicate wirelessly using near field technology; and
a secure element implemented as a single tamper-resistant integrated circuit that is configured to store one or more credentials that include a private key usable to perform one or more decryption operations without exposing the private key outside of the secure element and one or more credentials that are configured for involvement in the purchasing of the good or service.

19. A commerce card as described in claim 18, wherein the one or more credentials include credit card information include a credit card number, account holder's name, and expiration date.

20. A commerce card as described in claim 18, wherein the data includes an account balance.
